(19) United States
(12) Patent Application Publication
(10) Pub. No.: US 2026/0090545 A1
(43) Pub. Date: Apr. 2, 2026

(54) HERBICIDAL FORMULATIONS AND METHODS FOR THE TREATMENT OF DIFFICULT TO CONTROL WEED SPECIES

(71) Applicant: Discovery Purchaser Corporation, New York, NY (US)

(72) Inventors: David Spak, Cary, NC (US); Ronald Vermeer, Monheim am Rhein (DE)

(21) Appl. No.: 18/913,329

(22) Filed: Oct. 11, 2024

Related U.S. Application Data
(63) Continuation of application No. PCT/US2024/049271, filed on Sep. 30, 2024.

(51) Int. Cl. A01N 43/54; A01N 25/04; A01P 13/00

(52) U.S. Cl. CPC A01N 43/54; A01N 25/04; A01P 13/00

(57) ABSTRACT

Compositions and methods for controlling, mitigating, or reducing undesired vegetation including difficult to control weed species such as Juniper and Kochia. Methods for controlling, mitigating, or reducing undesired vegetation belonging to one or more difficult to control weed species may include applying to the undesired vegetation or its environment an herbicidally effective amount of an oil dispersion formulation, the oil dispersion formulation comprising aminocyclopyrachlor in a free-acid form suspended or dispersed in one or more oils.

### CROSS-REFERENCE TO RELATED APPLICATIONS

This application claims the benefit of priority to and is a continuation under 35 U.S.C. 111(a) of PCT/US2024/049271, filed Sep. 30, 2024, and titled “Herbicidal Formulations and Methods for the Treatment of Difficult to Control Weed Species,” the entire contents of which is hereby incorporated by reference, for all purposes, in its entirety.

### TECHNICAL FIELD

The present disclosure generally relates to compositions and methods for controlling, mitigating, or reducing undesired vegetation, particularly difficult to control weed species. More specifically, the present disclosure relates to, among other embodiments, methods for the preparation and use of herbicidal formulations for the treatment of difficult to control weed species, including Juniper and Kochia.

### BACKGROUND

Certain types of difficult to control weed species include woody plants, such as Juniper (Juniper spp.), Lespedeza (Lespedeza spp.), Sweetgum (Liquidambar styraciflua), and Loblolly Pine (Pinus taeda), as well as non-woody plants, such as Kochia (Bassia scoparia). For example, Juniper spp. includes a number of different species that grow in various regions of North America, such as Utah Juniper (Juniperus osteosperma), Rocky Mountain Juniper (Juniperus scopulorum), Western Juniper (Juniperus occidentalis), Eastern Red Cedar (Juniperus virginiana), and Ash Juniper (Juniperus ashei). In general, difficult to control weed species are not effectively controlled using broadcast and/or over-the-top applications of tank mixtures having one or more herbicidal active ingredients. The encroachment of such difficult to control weed species reduces rangeland production, increases fire risks, impacts hydrology and water resources, and reduces biodiversity and wildlife habitat. Many social and medical impacts have been documented, including school funding, health issues, allergies, tick born disease, lost herbaceous production, and lost rangeland production, among others. As such, there remains a need to develop effective treatments for the control such difficult to control weed species.

### SUMMARY

As noted, Juniper species are conifer trees that, along with other difficult to control weed species, are spreading across the U.S., threatening the rangeland biome, and invading utility and highway rights of way. None of the commercial herbicide solutions are very effective to treat these and many other difficult to control weed species. The active ingredient aminocyclopyrachlor is a synthetic auxin herbicide that provides control of some broadleaf weeds, brush, and tree species. The present disclosure provides new methods, compositions, and formulations of aminocyclopyrachlor that are effective for the treatment of difficult to control weed species, including Juniper and Kochia. Aminocyclopyrachlor is currently commercialized as a soluble liquid (SL) and is formulated in its salt form, either as potassium or triethyl-amine salt. The formulation is applied as a foliar spray after mixing with water. Because herbicide salts are not lipophilic (i.e., not lipid soluble), adjuvants or penetrants are mixed with the herbicide in the spray tank to allow plant uptake across the waxy cuticle or bark tissue to allow the herbicide to reach the site of action inside the plant. Once inside the plant, aminocyclopyrachlor salt is converted to the free-acid form, which is mobilized in the plant and reaches the sites of action. However, it is presently recognized that current products that include aminocyclopyrachlor in salt form do not effectively control all plant species due to inadequate uptake in above ground plant tissues. Furthermore, the use of additional tank mix adjuvants is complex and may lead to dosing errors, resulting in inferior biological control. Therefore, a technical problem to be solved by the present disclosure is improved methods, compositions, and formulations based on aminocyclopyrachlor that provide adequate control of Juniper and other difficult to control weed species. In certain embodiments, the present disclosure further provides improved in-can methods, compositions, and formulations that reduce the complexity of adding tank-mixes to the spray solution.

In order to address the aforementioned shortcomings of existing treatments, methods, and compositions, among others, the Applicant has developed new compositions, formulations, and methods related to the manufacture and use of herbicidal formulations for the treatment of difficult to control weed species. In particular, the present disclosure provides herbicidal compositions and formulations that include aminocyclopyrachlor in a free-acid form (e.g., 6-amino-5-chloro-2-cyclopropylpyrimidine-4-carboxylic acid). According to certain aspects of the present disclosure, an oil dispersion (OD) formulation containing aminocyclopyrachlor in a free-acid form suspended or dispersed in one or more oils, such as vegetable oil or mineral oi, is provided. It has been surprisingly discovered by the applicants that the presently disclosed oil dispersion formulations are effective for controlling, mitigating, or reducing undesired vegetation belonging to one or more difficult to control weed species, including, but not limited to, Juniper spp, Cedrus spp, Kochia, Lespedeza, Sweetgum, Loblolly Pine, Greenbrier, Yaupon Holly, Common Buckthorn, White Birch, Chinese Silverthorn, Leafy Spurge, Pigweed, Cinquefoil, Yellow Toadflax, Texas Bullnettle, Japanese Knotweed, Prickly Pear, Mesquite, Huisache, and Virginia Pine. The presently disclosed oil dispersion formulations are particularly effective for controlling, mitigating, or reducing Kochia as well as Juniper species, such as Juniperus osteosperma, Juniperus scopulorum, Juniperus occidentalis, Juniperus virginiana, Juniperus ashei, and Juniperus pinchotii. Additionally, the presently disclosed oil dispersion formulations are effective when applied to the undesired vegetation as a foliar spray.

The presently disclosed oil dispersion formulations may include from about 15 wt. % to about 70 wt. % of one or more oils. In certain embodiments, the one or more oils may comprise from about 56 wt. % to about 70 wt. % of the oil dispersion formulation. In some embodiments, the oil dispersion formulation may include greater than 55 wt. % of one or more oils. The one or more oils may include, for example, mineral oil, sunflower oil, rapeseed oil, soybean oil, and any combination thereof. In certain embodiments, the one or more oils may include a mineral oil or one or more petroleum-based aliphatic hydrocarbon oils. In other embodiments, the one or more oils may include vegetable oil, sunflower oil, soybean oil, or one or more vegetable-based aliphatic hydrocarbon oils.

The presently disclosed oil dispersion formulations may also include from about 5 wt. % to about 30 wt. % aminocyclopyrachlor in a free-acid form. In other embodiments, the oil dispersion formulations may include from about 5 wt. % to about 20 wt. % aminocyclopyrachlor in a free-acid form, or from about 7 wt. % to about 15 wt. % aminocyclopyrachlor in a free-acid form. The presently disclosed oil dispersion formulations may be prepared using or otherwise include crystals of free-acid aminocyclopyrachlor milled to an average particle size of less than about 15 micrometers (μm) (D₅₀). According to certain aspects, the aminocyclopyrachlor in a free-acid form and/or crystals thereof and may be homogeneously suspended or dispersed in the one or more oils and may, in some instances, further include at least one penetration promoter, at least one surfactant, and at least one emulsifier.

In certain aspects, the oil dispersion formulations may substantially exclude water. In some embodiments, the disclosed OD herbicidal formulations include one or more additives, such as one or more antifoam agents, one or more inert materials, one or more antioxidants, and/or one or more preservatives. In some embodiments, the OD herbicidal formulations may include one or more additional agrochemical and/or herbicidal active ingredients, such as metsulfuron-methyl, picloram, aminopyralid, 2,4-D, dicamba, chlorsulfuron, fluroxypyr, imazapyr, triclopyr, florpyrauxifen, and/or other suitable herbicidal active ingredients. In certain embodiments, the presently disclosed compositions may be prepared with in-can penetration enhancers to promote the effective uptake in the foliar plant tissue.

The present disclosure also provides methods for the treatment of difficult to control weed species, including Juniper and Kochia, using the presently disclosed oil dispersion (OD) formulations. In certain embodiments, the OD formulation may be applied directly to the undesired vegetation without dilution. In such instances, difficult to control weed species may be effectively controlled when the OD formulation is applied directly to the foliage as a foliar spray or when used as a spot spray or in a manner consistent with use an individual plant treatment (IPT). In other embodiments, the presently disclosed OD formulations may be combined with water or a water-based solution (e.g., a solution comprised mostly of water) to form a spray solution. In such embodiments, the presently disclosed methods for the treatment of difficult to control weed species, including Juniper and Kochia, may include applying the spray solution to the undesired vegetation or its environment. In certain embodiments, the method may include applying the spray solution as a foliar spray to the foliage of the undesired vegetation or may include applying the spray solution as a spot spray or in a manner consistent with use as an individual plant treatment (IPT).

In certain embodiments, the presently disclosed spray solutions may comprise from about 1 volume percent (vol. %) to about 15 vol. % of the OD formulation. According to certain aspects, the spray solutions may comprise at least 80 vol. % water, or from about 80 vol. % to about 99 vol. % water, or from about 85 vol. % to about 99 vol. % water. In certain embodiments, the spray solutions may comprise greater than 0.1 weight percent (wt. %) oil, or at least 0.13 wt. % oil, or from about 0.13 wt. % to about 8.90 wt. % oil. In certain embodiments, the spray solutions may include from about 82.0 wt. % to about 99.2 wt. % water. According to certain aspects, the spray solution may include from about 0.04 wt. % to about 4.0 wt. % aminocyclopyrachlor in a free-acid form. In certain embodiments, the spray solution may include from about 0.25 vol. % to about 2 vol. % methylated seed oil (MSO).

According to certain aspects of the present disclosure, the presently disclosed methods may include combining the oil dispersion formulation with water and one or more additional oils to form a spray solution. The one or more additional oils may include, for example, one or more aliphatic hydrocarbon oils. In such embodiments, the spray solution may include, in at least certain embodiments, from about 1 volume percent (vol. %) to about 15 vol. % of the OD formulation, from about 5 vol. % to about 25 vol. % one or more additional oils, and from about 60 vol. % to about 94 vol. % water. In certain embodiments, the spray solution may include less than 95 vol. % water, and/or may include at least 74 vol. % water, or at least 75 vol. % water, or at least 80 vol. % water. In certain embodiments, the spray solution may include from about 0.25 vol. % to about 2 vol. % methylated seed oil (MSO).

In certain embodiments, the spray solution may include less than 95% by weight water or may include from about 60% to about 94.9% by weight water. In some embodiments, the spray solution may include from about 0.13 wt. % to about 8.90 wt. % of one or more oils and from about 4.25 wt. % to about 21.25 wt. % of the one or more additional oils. According to certain aspects, the total amount by weight of oil in the spray solution may be at least 4.3 wt. %, the total amount of oil being the oil in the spray solution contributed by the one or more oils in the OD formulation as well as the one or more additional oils. In certain embodiments, the total amount of oil by weight in the spray solution may be from about 4.3% to about 30.2% by weight. In certain embodiments, the spray solution may include from about 0.13 wt. % to about 8.90 wt. % one or more oils, from about 4.25 wt. % to about 21.25 wt. % one or more additional oils, and from about 61.0 wt. % to about 94.9 wt. % water. According to certain aspects, the spray solution may include from about 0.04 wt. % to about 4.0 wt. % aminocyclopyrachlor in a free-acid form. In certain embodiments, the spray solution may include from about 0.20 wt. % to about 1.8 wt. % methylated seed oil (MSO).

The presently disclosed methods may include applying an herbicidally effective amount of the OD formulation and/or the spray solution to the undesired vegetation or its environment. In certain embodiments, the presently disclosed methods may include contacting the foliage of the undesired vegetation with an herbicidally effective amount of the oil dispersion formulation and/or the spray solution. In at least some instances, the presently disclosed methods may include performing a foliar spray treatment using the OD formulation or the spray solution. In certain instances, performing the foliar spray treatment may include applying the spray solution or OD formulation to the foliar surfaces of the difficult to control weed species at an application rate ranging from about 100 grams of the agrochemical active compound per hectare (g ai/ha) to about 140 g ai/ha. In other instances, performing the foliar spray treatment may include performing an individual plant treatment (IPT) of the difficult to control weed species. In still other instances, performing the foliar spray treatment may include performing a broadcast treatment of the difficult to control weed species and/or performing an aerial spray treatment of the difficult to control weed species using a plane, an aerial drone, a helicopter, or any combination thereof.

According to certain aspects of the present disclosure, the presently disclosed methods and compositions may be effective to cause the difficult to control weed species to demonstrate a greater than 30% foliar brown out 30 days after application. According to other aspects, the presently disclosed methods and compositions may be effective to cause the difficult to control weed species to demonstrates a greater than 50% foliar brown out, or greater than 60% foliar brown out, or at least 70% foliar brown out, 60 days after treatment or 90 days after application.

According to certain aspects of the present disclosure, when the presently disclosed OD formulations are combined or mixed with water to form a spray solution, an emulsion of the oil phase combined with a dispersion of the active ingredient may be formed. For example, the disclosed OD herbicidal formulations can be used to prepare water-based spray solutions or tank mixtures, with or without a spray adjuvant (e.g., methylated seed oil), one or more additional oils, and one or more additional herbicidal active ingredients (e.g., metsulfuron-methyl, picloram, aminopyralid, 2,4-D, dicamba, chlorsulfuron, fluroxypyr, imazapyr, triclopyr, florpyrauxifen, and/or other suitable herbicidal active ingredients). The spray solutions or tank mixtures can be used for foliar spray treatment (e.g., broadcast, over-the-top) of difficult to control weed species. The result is a substantial improvement in activity and control of Juniper and other difficult to control weed species. A further advantage of using the aminocyclopyrachlor in its acid form is the lower volatility of the product, which enables a lower risk of unwanted damage to neighboring crops. By dispersing the less-volatile acid form of aminocyclopyrachlor in an oil-based matrix, the present embodiments enable a more effective product with a low volatility. While not wishing to be bound by any particular theory, it is believed that the disclosed OD herbicidal formulations enable effective treatment of these difficult to control weed species by forming a longer lasting thin film on foliar surfaces, which enables the free-acid aminocyclopyrachlor to be absorbed into the difficult to control weed species over a longer period of time (e.g., 48 hours). In contrast, weed species treated with existing SC herbicidal formulations with aminocyclopyrachlor in salt form typically demonstrate a peak uptake of the aminocyclopyrachlor salt at approximately 4 to 8 hours. As such, the disclosed OD herbicidal formulations address the shortcomings of existing SC herbicidal formulations by enabling effective treatment of these difficult to control weed species.

Experimental results indicate that the disclosed OD herbicidal formulations enable effective treatment of difficult to control weed species, including various species of Juniper (e.g., Redberry Juniper, Eastern Red Cedar, Utah Juniper) and Kochia, and is believed to enable effective treatment of other difficult to control weed species, such as Lespedeza, Sweetgum, and Loblolly Pine. Indeed, it is believed that the disclosed OD herbicidal formulations enable effective treatment of other difficult to control weed species, including brush, vines, trees, and other undesirable weed or plant species. For example, it is believed that the disclosed OD herbicidal formulations enable effective treatment of other difficult to control weed species, such as Greenbrier, Yaupon Holly, Common Buckthorn, White Birch, Chinese Silverthorn, Leafy Spurge, Pigweed, Cinquefoil, Yellow Toadflax, Texas Bullnettle, Japanese Knotweed, Prickly Pear, Mesquite, Huisache, and Virginia Pine.

Aspects and advantages of these exemplary embodiments and other embodiments, are discussed in detail herein. Moreover, it is to be understood that both the foregoing information and the following detailed description provide merely illustrative examples of various aspects and embodiments, and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than may be necessary for a fundamental understanding of the embodiments discussed herein and the various ways in which they may be practiced. According to common practice, the various features of the drawings discussed below are not necessarily drawn to scale. Dimensions of various features and elements in the drawings may be expanded or reduced to more clearly illustrate embodiments of the disclosure.

FIG. 1 is a bar graph illustrating foliar brown out percentages for an experimental example in which Eastern Red Cedar plants were treated using different spray solutions and evaluated about 2 months after treatment, according to an embodiment.

FIG. 2 is a bar graph illustrating foliar brown out percentages for an experimental example in which different Eastern Red Cedar plants were treated using different spray solutions and evaluated about 3 months after treatment, according to an embodiment.

FIG. 3 is a bar graph illustrating phytotoxicity percentages for an experimental example in which different Eastern Red Cedar plants were treated using different spray solutions and evaluated about 2 months after treatment, according to an embodiment.

FIG. 4 is a reproduction of a photograph illustrating Kochia plants about twenty-eight (28) days after broadcast treatments were performed using different spray solutions.

### DETAILED DESCRIPTION

The present disclosure describes compositions, formulations, and methods related to the manufacture and use of herbicidal formulations for the treatment of difficult to control weed species. The description may use the phrases “in certain embodiments,” “in various embodiments,” “in an embodiment,” or “in embodiments,” which may each refer to one or more of the same or different embodiments. Furthermore, the terms “comprising,” “including,” “having,” and the like, as used with respect to embodiments of the present disclosure, are synonymous. The term “plurality” as used herein refers to two or more items or components. The terms “about” or “approximately” are defined as being close to as understood by one of ordinary skill in the art. In one non-limiting embodiment, these terms are defined to be within 10%, preferably within 5%, more preferably within 1%, and most preferably within 0.5%.

The terms “removing,” “removed,” “reducing,” “reduced,” or any variation thereof, when used in the claims and/or the specification includes any measurable decrease of one or more components in a mixture to achieve a desired result. The use of the words “a” or “an” when used in conjunction with any of the terms “comprising,” “including,” “containing,” or “having,” in the claims or the specification may mean “one,” but it is also consistent with the meaning of “one or more,” “at least one,” and “one or more than one.” The terms “wt. %”, “vol. %”, or “mol. %” refers to a weight, volume, or molar percentage of a component, respectively, based on the total weight, the total volume of material, or total moles, which includes the component. In a non-limiting example, 10 grams of component in 100 grams of the material is 10 wt. % of component.

As used herein, “ACP” generally refers to aminocyclopyrachlor, which can be in the form of free-acid ACP or an ACP salt. As used herein, the terms “free-acid aminocyclopyrachlor” and “free-acid ACP” specifically refer to 6-amino-5-chloro-2-cyclopropylpyrimidine-4-carboxylic acid, while the terms “aminocyclopyrachlor salt” and “ACP salt” specifically refer to a salt (e.g., a potassium salt, an alkyl amine salt) of 6-amino-5-chloro-2-cyclopropylpyrimidine-4-carboxylic acid. As used herein, “difficult to control weed species” includes any brush, vines, trees, and other undesirable weed or plant species that are not effectively controlled by treatments using current herbicidal formulations and treatments. A non-limiting list of example difficult to control weed species includes, but is not limited to: Juniper (e.g., Redberry Juniper, Eastern Red Cedar, Utah Juniper), Kochia, Lespedeza (e.g., Lespedeza spp.), Sweetgum (e.g., Liquidambar styraciflua), Loblolly Pine (e.g., Pinus taeda), Greenbrier (e.g., Smilax spp.), Yaupon Holly (e.g., Ilex vomitoria), Common Buckthorn (e.g., Rhamnus cathartica), White Birch (e.g., Betula papyrifera), Chinese Silverthorn (e.g., Elaeagnus pungens), Leafy Spurge (e.g., Euphorbia spp.), Pigweed (e.g., Amaranthus spp.), Lambsquarters (e.g., Chenopodium album), Cinquefoils (e.g., Potentilla spp.), Yellow Toadflax (e.g., Linaria vulgaris), Texas Bullnettle (e.g., Cnidoscolus texanus), Japanese Knotweed (e.g., Fallopia japonica), Prickly Pear (e.g., Opuntia spp.), Mesquite (e.g., Prosopis spp., Huisache (e.g., Acacia smallii Isley, Vachellia farnesiana); and Virginia Pine (e.g., Pinus virginiana).

Free-acid ACP oil dispersion (OD) formulations are disclosed herein for treatment of difficult to control weed species, including Juniper and Kochia. The OD formulations generally include at least one agrochemical active compound, at least one penetration promoter, at least one surfactant, at least one emulsifier, at least one oil, and, optionally, one or more additives (e.g., antifoam agents, inert materials, antioxidants, preservatives). The one or more agrochemical active compounds include at least free-acid ACP (i.e., 6-amino-5-chloro-2-cyclopropylpyrimidine-4-carboxylic acid). The OD formulations are homogeneous dispersions that demonstrate good stability. It is unexpected and surprising that these OD formulations exhibit a markedly better biological activity than commercial water-based suspension concentrate (SC) formulations that contain an ACP salt. The OD formulations favor the biological activity of the active components contained, such that, in comparison to conventional preparations, a higher activity is achieved, less active compound can be used while still providing effective control, or both.

As noted, the OD formulations contain at least free-acid ACP as an agrochemical active compound. In some embodiments, the OD formulations may include one or more additional agrochemical active compounds. For example, in some embodiments, the OD formulations include both free-acid ACP and a second agrochemical active compound (e.g., metsulfuron-methyl, picloram, aminopyralid, 2,4-D, dicamba, chlorsulfuron, fluroxypyr, imazapyr, triclopyr, florpyrauxifen, and/or other suitable herbicidal active ingredients). In certain embodiments, both the free-acid ACP and a second agrochemical active compound are solids at room temperature (e.g., at about 20 degrees Celsius (° C.)). In some embodiments, the OD formulations may contain from about 5 wt. % to about 30 wt. % (e.g., from about 5 wt. % to about 20 wt. %, from about 7 wt. % to about 15 wt. %) of the one or more agrochemical active compounds.

The OD formulations disclosed herein may contain one or more penetration promoters. A non-limiting list of example penetration promoters includes, but is not limited to, an isotridecanol ethoxylates, e-ethyl-hexyl alkoxylate, branched alcohol ethoxylate-propoxylates, and combinations thereof. In some embodiments, the OD formulations contain from about 5 wt. % to about 55 wt. %, or from about 15 wt. % to about 40 wt. % of the one or more penetration promoters.

The OD formulations disclosed herein may contain one or more surfactants. While referred to herein as surfactants, in some embodiments, the one or more surfactants of the OD formulations may function as surfactants, wetting agents, and/or dispersants. In general, the one or more surfactants are non-aqueous surfactants. In some embodiments, the one or more surfactants include anionic surfactants, nonionic surfactants, and blends of anionic and nonionic surfactants. A non-limiting list of example surfactants includes, but is not limited to, sodium salts of naphthalene sulfonate condensate (NSC) (e.g., anionic naphthalene sulphonate condensates), a tridecyl ether phosphate, an alkylarylsulphonate, an ethylhexanol, an alcohol ethoxylate, and combinations thereof. In some embodiments, the one or more surfactants may be present in a low moisture form. In some embodiments, the OD formulations contain from about 2.5 wt. % to about 25 wt. %, or from about 5 wt. % to about 20 wt. % of the one or more surfactants.

The OD formulations disclosed herein may contain one or more emulsifiers. A non-limiting list of example emulsifiers includes, but is not limited to, benzenesulfonic acid, 4-C10-13-sec[1]-alkyl derivatives, 2-propanamine, polyethylene glycol (PEG)-40 sorbitan peroleate, sorbitan trioleate ethoxylate, sorbitan monooleate, dodecylbenzolsulfonate isopropylammonium salt, and combinations thereof. In some embodiments, the OD formulations contain from about 4 wt. % to about 20 wt. %, or from about 5 wt. % to about 15 wt. % of the one or more emulsifiers.

The OD formulations disclosed herein may also include one or more oils. In certain embodiments, the one or more oils contain a vegetable oil, a mineral oil, or any combination of vegetable oil and mineral oil. A non-limiting list of example vegetable oil includes, but is not limited to, sunflower oil, rapeseed oil, and soybean oil. According to certain aspects, the one or more oils may be selected from vegetable oil, sunflower oil, soybean oil, and one or more other vegetable-based aliphatic hydrocarbon oils. In certain embodiments, the mineral oil is a mixture of liquid saturated hydrocarbons. In certain embodiments, the one or more oils may be selected from a mineral oil or one or more petroleum-based aliphatic hydrocarbon oils. The presently disclosed oil dispersion formulations may include from about 15 wt. % to about 70 wt. % of one or more oils. In certain embodiments, the one or more oils may comprise from about 56 wt. % to about 70 wt. % of the oil dispersion formulation. In other embodiments, the one or more oils may comprise from about 20 wt. % to about 45 wt. %, or from about 57 wt. % to about 70 wt. %, or from about 58 wt. % to about 70 wt. %, or from about 57 wt. % to about 65 wt. %, or from about 58 wt. % to about 65 wt. %, or from about 60 wt. % to about 70 wt. %, or from about 62 wt. % to about 70 wt. %, or from about 65 wt. % to about 70 wt. % of the oil dispersion formulation. In some embodiments, the oil dispersion formulation may include greater than 55 wt. % of one or more oils. In other embodiments, the oil dispersion formulation may include greater than 56 wt. %, or greater than 57 wt. %, or greater than 58 wt. %, or greater than 60 wt. %, or greater than 62 wt. %, or greater than 65 wt. % of one or more oils. In some embodiments, the weight ratio of oil to agrochemical active compound and/or the aminocyclopyrachlor in a free-acid form in the OD formulations is at least 3:1. In other embodiments, the weight ratio of the one or more oils to aminocyclopyrachlor in a free-acid form is from about 3:1 to about 14:1. In still other embodiments, the weight ratio of the one or more oils to aminocyclopyrachlor in a free-acid form may be from about 5:1 to about 14:1, or from about 7.5:1 to about 14:1, or from about 5:1 to about 10:1, or from about 10:1 to about 14:1, or from about 8:1 to about 14:1, or from about 8:1 to about 12:1, or from about 12:1 to about 14:1.

In certain embodiments, the OD formulations may contain one or more additives, such as antifoam agents, inert materials, antioxidants, and/or preservatives. In certain embodiments, the disclosed free-acid ACP OD formulations include other additives, such as inert fillers, pH adjusters (e.g., buffers), thickeners, dyes, antimicrobials, and/or colorants. In some embodiments, the OD formulations contain from about 0 wt. % to about 15 wt. % (e.g., from about 1 wt. % to about 10 wt. %) of the one or more additives. In some embodiments, the additives include one or more antifoaming agents, such as a silicon oil (e.g., a polyalkylsiloxane, polydimethylsiloxane) antifoaming agent. For example, in some embodiments, the OD formulations contain from about 0.04 wt. % to about 0.06 wt. % of one or more antifoaming agents. In some embodiments, the additives include one or more antioxidants, such as butylhydroxytoluene. For example, in some embodiments, the OD formulations contain from about 0.15 wt. % to about 0.25 wt. % of one or more antioxidants. In some embodiments, the additives include one or more inert materials or one or more preservatives.

Methods of manufacturing free-acid ACP OD formulations are disclosed herein. In general, the methods of manufacturing include milling an agrochemical active compound that is solid at room temperature (e.g., free-acid ACP) to yield a milled agrochemical active compound having an average particle size less than about 15 micrometers (μm) (D₅₀). In some embodiments, milling includes dry milling crystals of the agrochemical active compound (e.g., using a hammer mill or jet mill) to an average particle size ranging from about 1 μm to about 15 μm (D₅₀), or preferably from about 4 μm to about 10 μm (D₅₀). The methods of manufacturing include combining the milled agrochemical active compound with at least one penetration promoter, at least one surfactant, at least one emulsifier, at least one oil, and, optionally, one or more additives (e.g., antifoam agents, inert materials, antioxidants, preservatives), to yield an OD formulation as a homogeneous dispersion.

The present disclosure also provides methods for the treatment of difficult to control weed species, including Juniper and Kochia, using the presently disclosed oil dispersion (OD) formulations. In certain embodiments, the OD formulation may be applied directly to the undesired vegetation without dilution. In such instances, difficult to control weed species may be effectively controlled when the OD formulation is applied directly to the foliage as a foliar spray or when used as a spot spray or in a manner consistent with use an individual plant treatment (IPT). In other embodiments, the presently disclosed OD formulations may be combined with water or a water-based solution (e.g., a solution comprised mostly of water) to form a spray solution. In such embodiments, the presently disclosed methods for the treatment of difficult to control weed species, including Juniper and Kochia, may include applying the spray solution to the undesired vegetation or its environment. In certain embodiments, the method may include applying the spray solution as a foliar spray to the foliage of the undesired vegetation or may include applying the spray solution as a spot spray or in a manner consistent with use as an individual plant treatment (IPT).

In certain embodiments, the presently disclosed spray solutions may comprise from about 1 volume percent (vol. %) to about 15 vol. % of the OD formulation. In other embodiments, the spray solutions may include from about 1 volume percent (vol. %) to about 5 vol. % of the OD formulation, or from about 1 volume percent (vol. %) to about 10 vol. % of the OD formulation, or from about 2 volume percent (vol. %) to about 5 vol. % of the OD formulation, or from about 2 volume percent (vol. %) to about 8 vol. % of the OD formulation, or from about 5 volume percent (vol. %) to about 15 vol. % of the OD formulation, or from about 5 volume percent (vol. %) to about 10 vol. % of the OD formulation, or from about 1 volume percent (vol. %) to about 8 vol. % of the OD formulation.

According to certain aspects, the spray solutions may comprise at least 80 vol. % water. In other embodiments, the spray solutions may comprise at least 82 vol. % water, or at least 85 vol. % water, or at least 88 vol. % water, or at least 90 vol. % water, or at least 95 vol. % water. In other embodiments, the spray solutions may comprise from about 80 vol. % to about 99 vol. % water, or from about 85 vol. % to about 99 vol. % water, or from about 80 vol. % to about 90 vol. % water, or from about 90 vol. % to about 99 vol. % water, or from about 90 vol. % to about 95 vol. % water, or from about 95 vol. % to about 99 vol. % water. In certain embodiments, the spray solution may include one or more spray adjuvants. For example, the spray solution may include from about 0.25 vol. % to about 2 vol. % methylated seed oil (MSO).

In certain embodiments, the spray solutions may comprise greater than 0.1 weight percent (wt. %) of the one or more oils. In other embodiments, the spray solutions may comprise greater than 0.12 wt. %, or greater than 0.15 wt. %, or greater than 0.2 wt. %, or greater than 0.3 wt. %, or greater than 0.5 wt. %, or greater than 0.75 wt. %, or greater than 1.0 wt. %, or greater than 1.5 wt. %, or greater than 2.0 wt. % oil. In other embodiments, the spray solutions may comprise at least 0.13 wt. %, or at least 0.15 wt. %, or at least 0.2 wt. %, or at least 0.5 wt. %, or at least 0.75 wt. %, or at least 1.0 wt. %, or at least 1.25 wt. %, or at least 1.5 wt. %, or at least 2.0 wt. %, or at least 2.5 wt. %, or at least 5 wt. % oil. In certain embodiments, the spray solutions may comprise from about 0.13 wt. % to about 8.90 wt. % oil, or from about 0.15 wt. % to about 8.90 wt. % oil, or from about 0.2 wt. % to about 8.90 wt. % oil, or from about 0.5 wt. % to about 8.90 wt. % oil, or from about 0.75 wt. % to about 8.90 wt. % oil, or from about 1.0 wt. % to about 8.90 wt. % oil, or from about 1.25 wt. % to about 8.90 wt. % oil, or from about 1.50 wt. % to about 8.90 wt. % oil, or from about 2.0 wt. % to about 8.90 wt. % oil, or from about 2.5 wt. % to about 8.90 wt. % oil, or from about 5 wt. % to about 8.90 wt. % oil, or from about 0.15 wt. % to about 5.0 wt. % oil, or from about 1.0 wt. % to about 5.0 wt. % oil.

In certain embodiments, the spray solutions may include at least 82.0 wt. %, or at least 85.0 wt. %, or at least 88.0 wt. %, or at least 90 wt. %, or at least 92 wt. %, or at least 95 wt. %, or at least 98 wt. % water. In certain embodiments, the spray solutions may include from about 82.0 wt. % to about 99.2 wt. % water, or from about 85.0 wt. % to about 99.2 wt. % water, or from about 88.0 wt. % to about 99.2 wt. % water, or from about 90.0 wt. % to about 99.2 wt. % water, or from about 92.0 wt. % to about 99.2 wt. % water, or from about 95.0 wt. % to about 99.2 wt. % water, or from about 82.0 wt. % to about 95.0 wt. % water, or from about 82.0 wt. % to about 90.0 wt. % water, or from about 85.0 wt. % to about 99.2 wt. % water.

According to certain aspects, the spray solution may include from about 0.04 wt. % to about 4.0 wt. %, or from about 0.05 wt. % to about 4.0 wt. %, or from about 0.1 wt. % to about 4.0 wt. %, or from about 0.5 wt. % to about 4.0 wt. %, or from about 1.0 wt. % to about 4.0 wt. %, or from about 1.5 wt. % to about 4.0 wt. %, or from about 2.0 wt. % to about 4.0 wt. % aminocyclopyrachlor in a free-acid form.

According to certain aspects of the present disclosure, the presently disclosed methods may include combining the oil dispersion formulation with water and one or more additional oils to form a spray solution. The one or more additional oils may include, for example, one or more aliphatic hydrocarbon oils. In such embodiments, the spray solution may include, in at least certain embodiments, from about 1 volume percent (vol. %) to about 15 vol. % of the OD formulation, from about 5 vol. % to about 25 vol. % one or more additional oils, and from about 60 vol. % to about 94 vol. % water.

In other embodiments, the spray solutions may include from about 1 volume percent (vol. %) to about 5 vol. % of the OD formulation, or from about 1 volume percent (vol. %) to about 10 vol. % of the OD formulation, or from about 2 volume percent (vol. %) to about 5 vol. % of the OD formulation, or from about 2 volume percent (vol. %) to about 8 vol. % of the OD formulation, or from about 5 volume percent (vol. %) to about 15 vol. % of the OD formulation, or from about 5 volume percent (vol. %) to about 10 vol. % of the OD formulation, or from about 1 volume percent (vol. %) to about 8 vol. % of the OD formulation.

In certain embodiments, the spray solutions may include from about 5 vol. % to about 10 vol. % one or more additional oils, or from about 5 vol. % to about 15 vol. % one or more additional oils, or from about 5 vol. % to about 20 vol. % one or more additional oils, or from about 8 vol. % to about 15 vol. % one or more additional oils, or from about 10 vol. % to about 25 vol. % one or more additional oils, or from about 10 vol. % to about 15 vol. % one or more additional oils, or from about 10 vol. % to about 20 vol. % one or more additional oils, or from about 15 vol. % to about 25 vol. % one or more additional oils, or from about 15 vol. % to about 20 vol. % one or more additional oils.

In certain embodiments, the spray solutions may include at least 60.0 wt. %, or at least 65.0 vol. %, or at least 70.0 vol. %, or at least 74 vol. %, or at least 75.0 vol. %, or at least 80.0 vol. %, or at least 85.0 vol. %, or at least 90.0 vol. % water. In certain embodiments, the spray solutions may include from about 60.0 vol. % to about 90.0 vol. % water, or from about 65.0 vol. % to about 90.0 vol. % water, or from about 70.0 vol. % to about 85.0 vol. % water, or from about 75.0 vol. % to about 90.0 vol. % water, or from about 75.0 vol. % to about 85.0 vol. % water, or from about 65.0 vol. % to about 85.0 vol. % water, or from about 65.0 vol. % to about 80.0 vol. % water, or from about 70.0 vol. % to about 90.0 vol. % water, or from about 60.0 vol. % to about 85.0 vol. % water. In certain embodiments, the spray solution may include less than 95 vol. % water. In certain embodiments, the spray solution may include from about 0.25 vol. % to about 2 vol. % methylated seed oil (MSO).

In certain embodiments, the spray solution may include less than 95% by weight water. In other embodiments, the spray solutions may include at least 60.0 wt. %, or at least 65.0 wt. %, or at least 70.0 wt. %, or at least 74 wt. %, or at least 75.0 wt. %, or at least 80.0 wt. %, or at least 85.0 wt. %, or at least 90.0 wt. %, or at least 94 wt. % water. In certain embodiments, the spray solutions may include from about 60.0 wt. % to about 94.9 wt. % water. In other embodiments, the spray solutions may include from about 60.0 wt. % to about 90.0 wt. % water, or from about 65.0 wt. % to about 90.0 wt. % water, or from about 70.0 wt. % to about 85.0 wt. % water, or from about 75.0 wt. % to about 90.0 wt. % water, or from about 75.0 wt. % to about 85.0 wt. % water, or from about 65.0 wt. % to about 85.0 wt. % water, or from about 65.0 wt. % to about 80.0 wt. % water, or from about 70.0 wt. % to about 90.0 wt. % water, or from about 60.0 wt. % to about 85.0 wt. % water.

In certain embodiments, the spray solutions may comprise greater than 0.1 weight percent (wt. %) of the one or more oils. In other embodiments, the spray solutions may comprise greater than 0.12 wt. %, or greater than 0.15 wt. %, or greater than 0.2 wt. %, or greater than 0.3 wt. %, or greater than 0.5 wt. %, or greater than 0.75 wt. %, or greater than 1.0 wt. %, or greater than 1.5 wt. %, or greater than 2.0 wt. % oil. In other embodiments, the spray solutions may comprise at least 0.13 wt. %, or at least 0.15 wt. %, or at least 0.2 wt. %, or at least 0.5 wt. %, or at least 0.75 wt. %, or at least 1.0 wt. %, or at least 1.25 wt. %, or at least 1.5 wt. %, or at least 2.0 wt. %, or at least 2.5 wt. %, or at least 5 wt. % oil. In certain embodiments, the spray solutions may comprise from about 0.13 wt. % to about 8.90 wt. % oil, or from about 0.15 wt. % to about 8.90 wt. % oil, or from about 0.2 wt. % to about 8.90 wt. % oil, or from about 0.5 wt. % to about 8.90 wt. % oil, or from about 0.75 wt. % to about 8.90 wt. % oil, or from about 1.0 wt. % to about 8.90 wt. % oil, or from about 1.25 wt. % to about 8.90 wt. % oil, or from about 1.50 wt. % to about 8.90 wt. % oil, or from about 2.0 wt. % to about 8.90 wt. % oil, or from about 2.5 wt. % to about 8.90 wt. % oil, or from about 5 wt. % to about 8.90 wt. % oil, or from about 0.15 wt. % to about 5.0 wt. % oil, or from about 1.0 wt. % to about 5.0 wt. % oil.

In some embodiments, the spray solution may include from about 4.25 wt. % to about 21.25 wt. % of the one or more additional oils. In other embodiments, the spray solution may include from about 4.25 wt. % to about 18.0 wt. % of the one or more additional oils, or from about 4.25 wt. % to about 15.0 wt. % of the one or more additional oils, or from about 4.25 wt. % to about 12.0 wt. % of the one or more additional oils, or from about 4.25 wt. % to about 10.0 wt. % of the one or more additional oils, or from about 5.0 wt. % to about 20.0 wt. % of the one or more additional oils, or from about 5.0 wt. % to about 10.0 wt. % of the one or more additional oils, or from about 5.0 wt. % to about 15.0 wt. % of the one or more additional oils.

According to certain aspects, the total amount by weight of oil in the spray solution may be at least 4.3 wt. %, or at least 4.5 wt. %, or at least 5.0 wt. %, or at least 7.5 wt. %, or at least 8.5 wt. %, or at least 10.0 wt. %, or at least 12.0 wt. %, or at least 15.0 wt. %, or at least 20.0 wt. %. As used herein, the term “total amount by weight of oil in the spray solution,” in all of its forms, refers to the total amount of oil in the spray solution contributed by the one or more oils in the OD formulation as well as the one or more additional oils added to the OD formulation and water to prepare the spray solution. In certain embodiments, the total amount of oil by weight in the spray solution may be from about 4.3% to about 30.2% by weight, or from about 4.5% to about 30.0% by weight, or from about 5.0% to about 30.0% by weight, or from about 5.0% to about 25.0% by weight, or from about 10.0% to about 25.0% by weight, or from about 15.0% to about 30.0% by weight. According to certain aspects, the spray solution may include from about 0.04 wt. % to about 4.0 wt. % aminocyclopyrachlor in a free-acid form. In certain embodiments, the spray solution may include from about 0.20 wt. % to about 1.8 wt. % methylated seed oil (MSO).

The spray solutions may optionally contain at least one additional agrochemical active compound and/or at least one spray adjuvant. For example, in some embodiments, the spray solutions may contain from about 0.5 vol. % to about 10 vol. % of the additional agrochemical active compound. In certain embodiments, the spray solutions may contain, for example, one or more additional agrochemical active compounds selected from metsulfuron-methyl, picloram, aminopyralid, 2,4-D, dicamba, chlorsulfuron, fluroxypyr, imazapyr, triclopyr, florpyrauxifen, and any combination thereof. In some embodiments, the spray solutions may contain from about 0.25 vol. % to about 2 vol. % of a methylated seed oil (MSO) as the spray adjuvant.

The presently disclosed methods of using the presently disclosed OD formulations and spray solutions may include performing a foliar spray treatment of the difficult to control weed species with any one of the presently disclosed OD formulations or spray solutions. For example, in certain embodiments, performing the foliar spray treatment may include applying the spray solution to foliar surfaces of the difficult to control weed species at an application rate ranging from about 100 grams of the agrochemical active compound per hectare (g ai/ha) to about 140 g ai/ha. In some embodiments, the foliar spray treatment can be conducted as a performing an aerial spray treatment of the difficult to control weed species using a plane, an aerial drone, a helicopter, or any combination thereof. In certain embodiments, performing the foliar spray treatment includes performing individual plant treatment (IPT) of the difficult to control weed species, while in other embodiments, performing the foliar spray treatment comprises performing a broadcast treatment of the difficult to control weed species. In some embodiments, the difficult to control weed species includes Kochia, Lespedeza, Sweetgum, Loblolly Pine, or any combination thereof. In some embodiments, the difficult to control weed species include those of Juniper spp and/or Cedrus spp. In certain embodiments, the difficult to control weed species includes Juniperus osteosperma, Juniperus scopulorum, Juniperus occidentalis, Juniperus virginiana, Juniperus ashei, Juniperus pinchotii, or any combination thereof. Indeed, it is believed that the disclosed OD herbicidal formulations, and spray solutions comprising the OD formulations, enable effective treatment of other difficult to control weed species, including brush, vines, trees, and other undesirable weed or plant species. For example, it is believed that the disclosed OD herbicidal formulations enable effective treatment of other difficult to control weed species, such as Greenbrier, Yaupon Holly, Common Buckthorn, White Birch, Chinese Silverthorn, Leafy Spurge, Pigweed, Cinquefoil, Yellow Toadflax, Texas Bullnettle, Japanese Knotweed, Prickly Pear, Mesquite, Huisache, and Virginia Pine.

In some embodiments, the difficult to control weed species demonstrates a greater than 30% foliar brown out 30 days after treatment. In some embodiments, the difficult to control weed species demonstrates a greater than 50% foliar brown out 60 days after treatment or 90 days after treatment. In some embodiments, the difficult to control weed species demonstrates a greater than 60% foliar brown out 60 days after treatment or 90 days after treatment. In some embodiments, the difficult to control weed species demonstrates at least 70% foliar brown out 60 days after treatment or 90 days after treatment.

TABLE 1
Example Free-Acid ACP OD 100 (100 g/L) Formulation in Vegetable Oil.
Free-Acid ACP OD 100 (100 g/L) Formulation in Vegetable Oil

| Role | Component | wt. % | g/L |
|---|---|---|---|
| Agrochemical active | Free-acid ACP | 8.93 | 100.00 |
| Penetration Promoters | e-ethyl-hexyl alkoxylate | 20.00 | 224.00 |
| Surfactants | alkylarylsulphonate, | 13.10 | 146.72 |
| | ethylhexanol and alcohol | | |
| | ethoxylate | | |
| Emulsifiers | PEG-40 Sorbitan Peroleate | 10.00 | 112.00 |
| Antioxidants | Butylhydroxytoluene | 0.20 | 2.24 |
| Antifoaming Agents | Silicon Oil | 0.05 | 0.56 |
| Oils | Sunflower oil | 47.72 | 534.48 |

TABLE 2
Example Free-Acid ACP OD 100 (100 g/L) Formulation in Mineral Oil.
Free-Acid ACP OD 100 (100 g/L) Formulation in Mineral Oil

| Role | Component | wt. % | g/L |
|---|---|---|---|
| Agrochemical active | Free-acid ACP | 8.93 | 100.00 |
| Penetration Promoters | isotridecanol ethoxylate | 15.57 | 174.38 |
| Surfactants | sodium salt of naphthalene | 4.00 | 44.80 |
| | sulfonate condensate, | | |
| | tridecyl ether phosphate | | |
| Emulsifiers | Benzenesulfonic acid, | 7.79 | 87.25 |
| | 4-C10-13-sec[1]alkyl | | |
| | derivatives, 2-propanamine | | |
| Antifoaming Agents | Silicon Oil | 0.10 | 1.12 |
| Oils | Mineral Oil | 63.61 | 712.45 |

### Example 1: Treatment of Eastern Red Cedar

An experimental treatment of Eastern Red Cedar (Juniperus virginiana) was performed in North Carolina, U.S.A., using spray solutions prepared using the example free-acid ACP OD formulation in vegetable oil, as indicated in Table 1, and using spray solutions prepared using the example free-acid ACP OD formulation in mineral oil, as indicated in Table 2. These free-acid ACP OD formulations were evaluated in comparison to spray solutions prepared using the Method® 240SL herbicidal formulation, which is commercially available from Environmental Science U.S., LLC. Three spray solutions were prepared in water using different amounts of each of these formulations.

In particular, the three spray solutions prepared using the Method® 240SL herbicidal formulation included a first spray solution containing 0.5 vol. % of the herbicidal formulation, a second spray solution containing 1.0 vol. % of the herbicidal formulation, and a third spray solution containing 2.0 vol. % of the herbicidal formulation. The three spray solutions prepared using the free-acid ACP OD formulation in vegetable oil included a first spray solution containing 1.06 vol. % of the herbicidal formulation, a second spray solution containing 2.12 vol. % of the herbicidal formulation, and a third spray solution containing 4.24 vol. % of the herbicidal formulation. The three spray solutions prepared using the free-acid ACP OD formulation in mineral oil included a first spray solution containing 1.06 vol. % of the herbicidal formulation, a second spray solution containing 2.12 vol. % of the herbicidal formulation, and a third spray solution containing 4.24 vol. % of the herbicidal formulation. All of the spray solutions included 1 vol. % of methylated seed oil (MSO) as a spray adjuvant.

It may be appreciated that for Examples 1-4, the OD formulations contained 100 grams (g) ACP free-acid per liter (L) while the Method® 240SL herbicidal formulations contained the equivalent of 240 grams (g) of ACP per liter (L). Therefore, in order to compare both formulations on an equal ACP free-acid equivalent basis, the OD formulations should have been applied at a rate of 2.4 times the rate that the Method® 240SL herbicidal formulations were applied on a volume basis. However, the OD formulations were applied at a 2.12 times rate resulting in the two formulations not being compared on a completely equal ACP free acid basis. In particular, the OD formulations were applied at a 12% less ACP active herbicidal ingredient rate as compared to the Method® 240SL herbicidal formulations.

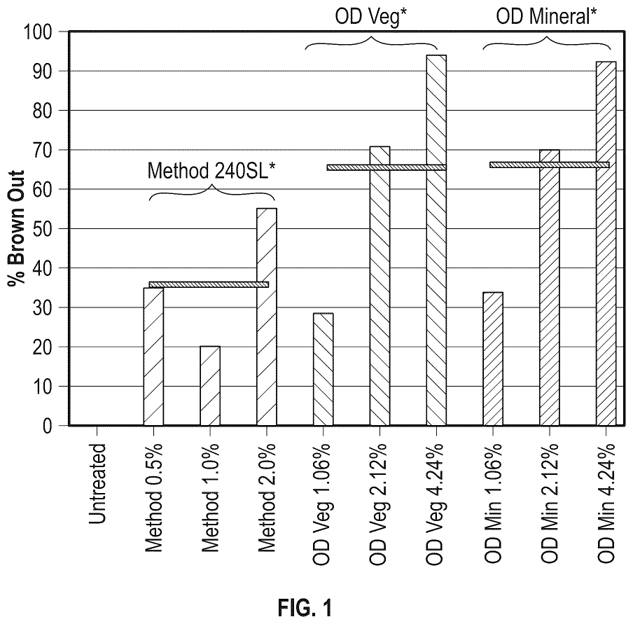

The spray solutions were individually applied to different Eastern Red Cedar plants ranging in height from about 2 feet (ft.) (about 60 centimeters (cm)) to about 5 ft (about 150 cm). The foliar brown out percentages of these plants were evaluated about 2 months (about 60 days) after treatment, as illustrated by the bar graph of FIG. 1. The horizontal black bars indicate the average foliar brown out observed across the first, second, and third spray solutions for each of the formulations. The spray solutions prepared using the Method® 240SL herbicidal formulation demonstrated limited ability to induce foliar brown out in the treated plants, even at the highest loading of the third spray solution. Additionally, the three spray solutions prepared using the Method® 240SL herbicidal formulation provided an average foliar brown out of only about 36% across the three tank mixtures. The three spray solutions prepared using the free-acid ACP OD formulation in vegetable oil and the three spray solutions prepared using the free-acid ACP OD formulation in mineral oil demonstrated similar performance to one another, and demonstrated superior treatment effectiveness at the higher loadings of the second and third spray solutions relative to the second and third spray solutions prepared using the Method® 240SL herbicidal formulation. The spray solutions prepared using the free-acid ACP OD formulation in vegetable oil and using the free-acid ACP OD formulation in mineral oil enabled an average foliar brown out of about 65% across all three spray solutions. As such, despite the higher amounts of active ingredient in the spray solutions prepared using the Method® 240SL herbicidal formulation, the spray solutions prepared using the free-acid ACP OD formulations enabled more effective control of Eastern Red Cedar at about 2 months after treatment.

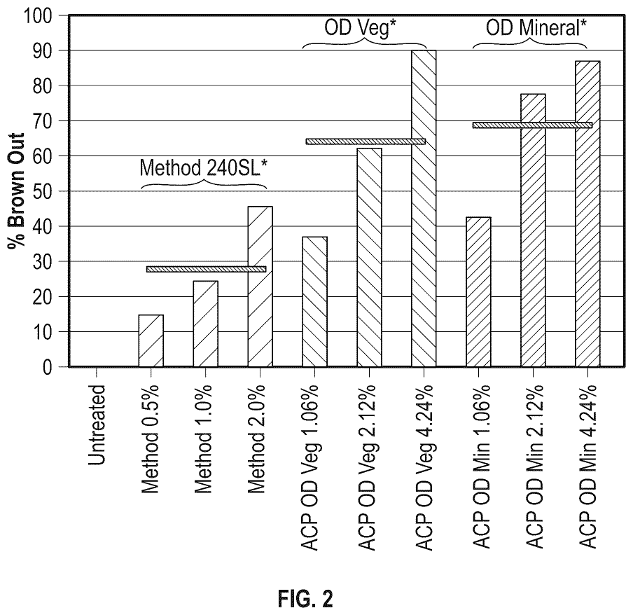

The foliar brown out percentages of Eastern Red Cedar plants were further evaluated about 3 months (about 90 days) after treatment, as illustrated by the bar graph of FIG. 2. The horizontal black bars indicate the average foliar brown out observed across the first, second, and third spray solutions for each of the formulations. The spray solutions prepared using the Method® 240SL herbicidal formulation demonstrated limited ability to induce foliar brown out in the treated plants, even at the highest loading of the third spray solution. Additionally, the three spray solutions prepared using the Method® 240SL herbicidal formulation provided an average foliar brown out of only about 28% across the three spray solutions. For the three spray solutions prepared using the Method® 240SL herbicidal formulation, the decrease in average foliar brown out at about 2 months (36%) relative to the average foliar brown out at about 3 months (28%) indicates that the treated plants demonstrated undesirable recovery in the time window between evaluations. The three spray solutions prepared using the free-acid ACP OD formulation in vegetable oil and the three spray solutions prepared using the free-acid ACP OD formulation in mineral oil demonstrated similar performance to one another, and demonstrated superior treatment effectiveness at the higher loadings of the second and third spray solutions relative to the second and third spray solutions prepared using the Method® 240SL herbicidal formulation. The spray solutions prepared using the free-acid ACP OD formulation in vegetable oil enabled an average foliar brown out of about 65% across all three spray solutions, while the spray solutions prepared using the free-acid ACP OD formulation in mineral oil enabled an average foliar brown out of about 68% across all three spray solutions. Accordingly, the plants treated using the spray solutions prepared using the free-acid ACP OD formulations did not demonstrate the same undesirable recovery in the time window between evaluations as the plants treated using the spray solutions prepared using the Method® 240SL herbicidal formulation. As such, despite the higher amounts of active ingredient in the spray solutions prepared using the Method® 240SL herbicidal formulation, the spray solutions prepared using the free-acid ACP OD formulations enabled more effective control of Eastern Red Cedar at about 3 months after treatment.

### Example 2: Treatment of Eastern Red Cedar

An experimental treatment of Eastern Red Cedar (Juniperus virginiana) was performed in Nebraska, U.S.A., using spray solutions prepared using the example free-acid ACP OD formulation in vegetable oil, as indicated in Table 1, and using spray solutions prepared using the example free-acid ACP OD formulation in mineral oil, as indicated in Table 2. These free-acid ACP OD formulations were evaluated in comparison to spray solutions prepared using the commercially available Method® 240SL herbicidal formulation. Three spray solutions were prepared in water using different amounts of each of these formulations.

In particular, the three spray solutions prepared using the Method® 240SL herbicidal formulation included a first spray solution containing 0.5 vol. % of the herbicidal formulation, a second spray solution containing 1.0 vol. % of the herbicidal formulation, and a third spray solution containing 2.0 vol. % of the herbicidal formulation. The three spray solutions prepared using the free-acid ACP OD formulation in vegetable oil included a first spray solution containing 1.2 vol. % of the herbicidal formulation, a second spray solution containing 2.4 vol. % of the herbicidal formulation, and a third spray solution containing 4.8 vol. % of the herbicidal formulation. The three spray solutions prepared using the free-acid ACP OD formulation in mineral oil included a first spray solution containing 1.2 vol. % of the herbicidal formulation, a second spray solution containing 2.4 vol. % of the herbicidal formulation, and a third spray solution containing 4.8 vol. % of the herbicidal formulation. For this example, all of the spray solutions included 1 vol. % of methylated seed oil (MSO) as a spray adjuvant.

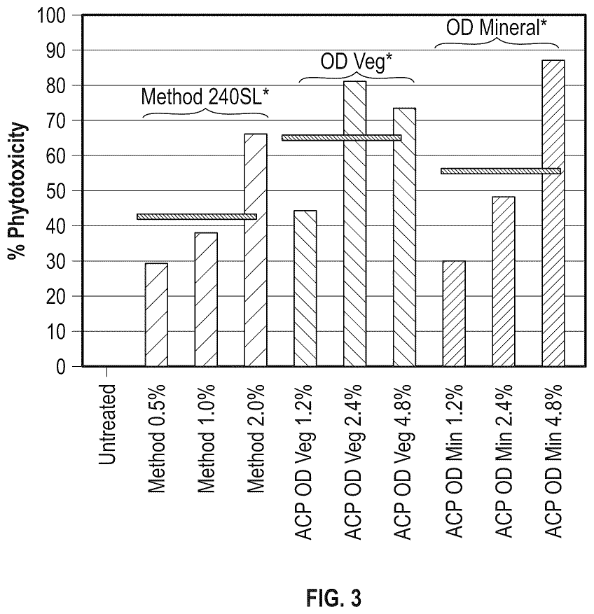

The spray solutions were individually applied to different Eastern Red Cedar plants ranging in height from about 2 feet (ft.) (about 60 centimeters (cm)) to about 5 ft (about 150 cm). The phytotoxicity percentages of these plants were evaluated about 2 months (about 60 days) after treatment, as illustrated by the bar graph of FIG. 3. The horizontal black bars indicate the average phytotoxicity observed across the first, second, and third spray solutions for each of the formulations. The spray solutions prepared using the Method® 240SL herbicidal formulation demonstrated limited phytotoxicity in the treated plants, especially at the lower loading of the first and second spray solutions. Additionally, the three spray solutions prepared using the Method® 240SL herbicidal formulation provided an average phytotoxicity of only about 42% across the three spray solutions. The second and third spray solutions prepared using the free-acid ACP OD formulation in vegetable oil and the third spray solution prepared using the free-acid ACP OD formulation in mineral oil demonstrated superior treatment relative to the spray solutions prepared using the Method® 240SL herbicidal formulation. The spray solutions prepared using the free-acid ACP OD formulation in vegetable oil enabled an average phytotoxicity of about 66% across all three spray solutions. The spray solutions prepared using the free-acid ACP OD formulation in mineral oil enabled an average phytotoxicity of about 55% across all three spray solutions. As such, despite the higher amounts of active ingredient in the spray solutions prepared using the Method® 240SL herbicidal formulation, the spray solutions prepared using the free-acid ACP OD formulations enabled more effective control of Eastern Red Cedar at about 2 months after treatment.

### Example 3: Treatment of Kochia

An experimental treatment of Kochia (Bassia scoparia) was performed using a spray solution prepared using the example free-acid ACP OD formulation in vegetable oil, as indicated in Table 1, and using a spray solution prepared using the example free-acid ACP OD formulation in mineral oil, as indicated in Table 2. These free-acid ACP OD formulations were evaluated in comparison to a spray solution prepared using the Method® 240SL herbicidal formulation. In particular, the spray solution prepared using the Method® 240SL herbicidal formulation enabled an active ingredient application rate of about 140 g ai/h. The spray solution prepared using the free-acid ACP OD formulation in vegetable oil enabled an active ingredient application rate of about 140 g ai/h, and the spray solution prepared using the free-acid ACP OD formulation in mineral oil enabled an active ingredient application rate of about 140 g ai/h.

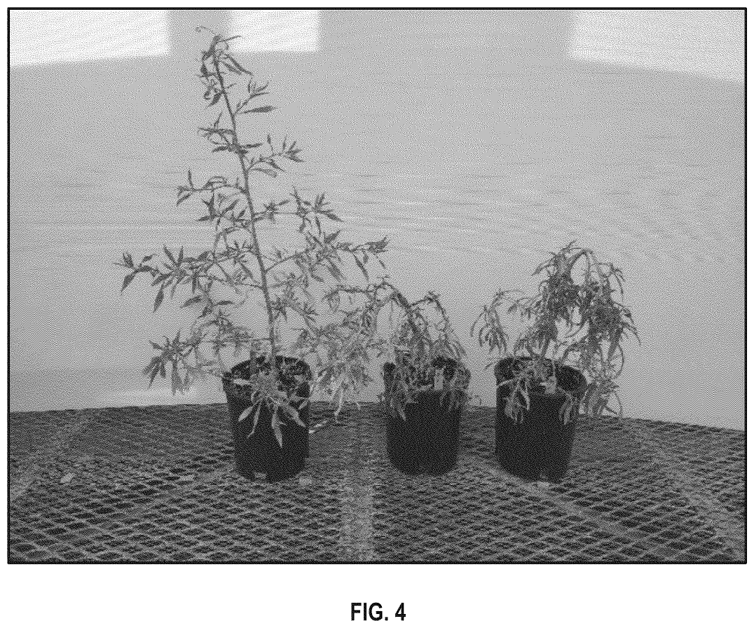

The spray solutions were individually applied to different Kochia plants using a broadcast treatment. FIG. 4 is a reproduction of a photograph illustrating the results about twenty-eight (28) days after treatment. In FIG. 4, the Kochia plant on the left is an example Kochia plant treated with the spray solution prepared using the Method® 240SL herbicidal formulation, the Kochia plant in the middle is an example Kochia plant treated with the spray solution prepared using the free-acid ACP OD formulation in vegetable oil, and the Kochia plant on the right is an example Kochia plant treated with the spray solution prepared using the free-acid ACP OD formulation in mineral oil. The Kochia plant treated using the Method® 240SL herbicidal formulation demonstrated only a minor amount of foliar brown out and the stem of the plant remained upright. In contrast, the Kochia plants treated using the free-acid ACP OD formulations demonstrated substantial bending of the stem and drooping, in addition to a minor amount of foliar brown out. As such, despite the higher active ingredient application rates for the spray solution prepared using the Method® 240SL herbicidal formulation, the spray solutions prepared using the free-acid ACP OD formulations enabled more effective control of Kochia at about twenty-eight (28) days after treatment.

### Example 4: Example Spray Solutions Prepared Using Oil Dispersion (OD) Formulations

Various example spray solutions may be prepared using any of the OD formulations presented in Table 3. The approximate compositional ranges, in both volume percent (vol. %) and weight percent (wt. %), of example spray solutions that may be prepared according to certain embodiments of the present disclosure are provided in Table 4.

TABLE 3
Oil Dispersion (OD) Formulations

| Component | wt. % |
|---|---|
| Free-acid ACP | 5-30 |
| One or more oils | 15-70 |
| At least one emulsifier | 4-20 |
| At least one surfactant | 2.5-25 |
| At least one penetration promoter | 5-55 |
| One or more additives (e.g., antifoaming agents, inert | 0-15 |
| materials, antioxidants, preservatives) | |

TABLE 4
Spray Solution Compositions

| Spray | | | Vol. % | One or | | | |
|---|---|---|---|---|---|---|---|
| Solution | Vol. % OD | Vol. % | Additional | more oil | Additional | Total Oil | Water |
| Example | Formulation | Water | Oil | (wt. %) | oil (wt. %) | (wt. %) | (wt. %) |
| 6-1 | 1 | 99 | 0 | 0.13-0.60 | 0 | 0.13-0.60 | 99.2 |
| 6-2 | 2 | 98 | 0 | 0.26-1.19 | 0 | 0.26-1.19 | 98.3 |
| 6-3 | 5 | 95 | 0 | 0.64-2.98 | 0 | 0.64-2.98 | 95.8 |
| 6-4 | 10 | 90 | 0 | 1.28-5.95 | 0 | 1.28-5.95 | 91.5 |
| 6-5 | 15 | 85 | 0 | 1.91-8.93 | 0 | 1.91-8.93 | 87.3 |
| 6-6 | 1 | 94 | 5 | 0.13-0.60 | 4.25 | 4.38-4.85 | 94.9 |
| 6-7 | 5 | 85 | 10 | 0.64-2.98 | 8.50 | 9.1-12.1 | 87.3 |
| 6-8 | 5 | 80 | 15 | 0.64-2.98 | 12.75 | 13.4-15.7 | 83.0 |
| 6-9 | 10 | 70 | 20 | 1.28-5.95 | 17 | 18.3-23.0 | 74.5 |
| 6-10 | 15 | 60 | 25 | 1.91-8.93 | 21.25 | 23.2-30.2 | 66.0 |

Other objects, features, and advantages of the disclosure will become apparent from the foregoing figures, detailed description, and examples. It should be understood, however, that the figures, detailed description, and examples, while indicating specific embodiments of the disclosure, are given by way of illustration only and are not meant to be limiting. Additionally, it is contemplated that changes and modifications within the spirit and scope of the disclosure will become apparent to those skilled in the art from the detailed description. In further embodiments, features from specific embodiments may be combined with features from other embodiments. For example, features from one embodiment may be combined with features from any of the other embodiments. In further embodiments, additional features may be added to the specific embodiments described herein.

### STATEMENTS OF THE DISCLOSURE

Statement 1. A method for controlling, mitigating, or reducing undesired vegetation belonging to one or more difficult to control weed species, the method comprising: applying to the undesired vegetation or its environment an herbicidally effective amount of an oil dispersion formulation, the oil dispersion formulation comprising aminocyclopyrachlor in a free-acid form suspended or dispersed in one or more oils.
Statement 2. The method according to Statement 1, wherein the aminocyclopyrachlor in a free-acid form comprises 6-amino-5-chloro-2-cyclopropylpyrimidine-4-carboxylic acid.
Statement 3. The method according to Statement 1 or Statement 2, wherein the undesired vegetation is selected from the group consisting of Juniperus osteosperma, Juniperus scopulorum, Juniperus occidentalis, Juniperus virginiana, Juniperus ashei, Juniperus pinchotii, and any combination thereof.
Statement 4. The method according to Statement 1 or Statement 2, wherein the one or more difficult to control weed species comprises one or more species selected from the group consisting of Juniper spp, Cedrus spp, Kochia, Lespedeza, Sweetgum, Loblolly Pine, Greenbrier, Yaupon Holly, Common Buckthorn, White Birch, Chinese Silverthorn, Leafy Spurge, Pigweed, Cinquefoil, Yellow Toadflax, Texas Bullnettle, Japanese Knotweed, Prickly Pear, Mesquite, Huisache, and Virginia Pine, and any combination thereof.
Statement 5. The method according to any of Statements 1-4, wherein applying to the undesired vegetation or its environment comprises contacting the foliage of the undesired vegetation with an herbicidally effective amount of the oil dispersion formulation.
Statement 6. The method according to any of Statements 1-5, wherein applying to the undesired vegetation or its environment comprises applying the oil dispersion formulation as a foliar spray to the foliage of the undesired vegetation.
Statement 7. The method according to Statement 5 or Statement 6, wherein the method is effective to control, mitigate, or reduce the undesired vegetation in the absence of contacting the stem or trunk of the undesired vegetation with the oil dispersion formulation.
Statement 8. The method according to any one of Statements 1-7, wherein the oil dispersion formulation comprises from about 15 wt. % to about 70 wt. % of the one or more oils.
Statement 9. The method according to any one of Statements 1-7, wherein the one or more oils comprises greater than about 55 wt. % of the oil dispersion formulation.
Statement 10. The method according to any one of Statements 1-7, wherein the one or more oils comprises from about 56 wt. % to about 70 wt. % of the oil dispersion formulation.
Statement 11. The method according to any one of Statements 1-10, wherein the one or more oils is selected from the group consisting of mineral oil, sunflower oil, rapeseed oil, soybean oil, and any combination thereof.
Statement 12. The method according to any one of Statements 1-10, wherein the one or more oils is selected from mineral oil or one or more other petroleum-based aliphatic hydrocarbon oils.
Statement 13. The method according to any one of Statements 1-10, wherein the one or more oils is selected from vegetable oil, sunflower oil, soybean oil, or one or more other vegetable-based aliphatic hydrocarbon oils.
Statement 14. The method according to any one of Statements 1-13, wherein the oil dispersion formulation is applied directly to the undesired vegetation without dilution.
Statement 15. The method according to any one of Statements 1-14, wherein the oil dispersion formulation substantially excludes water.
Statement 16. The method according to any one of Statements 1-15, wherein applying to the undesired vegetation or its environment an herbicidally effective amount of an oil dispersion formulation comprises: combining the oil dispersion formulation with water or a water-based solution to form a spray solution; and applying the spray solution to the undesired vegetation or its environment.
Statement 17. The method according to Statement 16, wherein the spray solution comprises from about 1 volume percent (vol. %) to about 15 vol. % of the OD formulation and at least 80 vol. % water.
Statement 18. The method according to Statement 17, wherein the spray solution comprises from about 80 vol. % to about 99 vol. % water.
Statement 19. The method according to Statement 17, wherein the spray solution comprises from about 85 vol. % to about 99 vol. % water.
Statement 20. The method according to Statement 17, wherein the spray solution comprises from about 0.25 vol. % to about 2 vol. % methylated seed oil (MSO).
Statement 21. The method according to Statement 16, wherein the spray solution comprises from about 0.13 wt. % to about 8.90 wt. % oil.
Statement 22. The method according to Statement 16, wherein the spray solution comprises greater than 0.1 wt. % oil.
Statement 23. The method according to Statement 16, wherein the spray solution comprises at least 0.13 wt. % oil.
Statement 24. The method according to Statement 16 or Statement 21, wherein the spray solution comprises from about 82.0 wt. % to about 99.2 wt. % water.
Statement 25. The method according to any one of Statements 21-24, wherein the spray solution comprises from about 0.20 wt. % to about 1.8 wt. % methylated seed oil (MSO).
Statement 26. The method according to any one of Statements 1-15, wherein applying to the undesired vegetation or its environment an herbicidally effective amount of an oil dispersion formulation comprises: combining the oil dispersion formulation with water and one or more additional oils to form a spray solution; and applying the spray solution to the undesired vegetation or its environment.
Statement 27. The method according to Statement 26, wherein the one or more additional oils comprises one or more aliphatic hydrocarbon oils.
Statement 28. The method according to Statement 26 or Statement 27, wherein the spray solution comprises less than 95 vol. % water.
Statement 29. The method according to Statement 26 or Statement 27, wherein the spray solution comprises: from about 1 volume percent (vol. %) to about 15 vol. % OD formulation; from about 5 vol. % to about 25 vol. % one or more additional oils; and from about 60 vol. % to about 94 vol. % water.
Statement 30. The method according to Statement 28 or Statement 29, wherein the spray solution comprises at least 74 vol. % water.
Statement 31. The method according to Statement 28 or Statement 29, wherein the spray solution comprises at least 75 vol. % water.
Statement 32. The method according to Statement 28 or Statement 29, wherein the spray solution comprises at least 80 vol. % water.
Statement 33. The method according to any one of Statements 28-32, wherein the spray solution comprises from about 0.25 vol. % to about 2 vol. % methylated seed oil (MSO).
Statement 34. The method according to Statement 26 or Statement 27, wherein the spray solution comprises less than 95% by weight water.
Statement 35. The method according to Statement 26 or Statement 27, wherein the spray solution comprises from about 60% to about 94.9% by weight water.
Statement 36. The method according to any Statement 34 or Statement 35, wherein the total amount by weight of oil in the spray solution is at least 4.3 wt. %, the total amount of oil being the oil in the spray solution contributed by the one or more oils in the OD formulation and the one or more additional oils.
Statement 37. The method according to any Statement 34 or Statement 35, wherein the total oil weight percentage of the spray solution comprises from about 4.3% to about 30.2% by weight oil, the total oil weight percentage being the combined weight percentage of the oil in the spray solution contributed by the one or more oils in the OD formulation and the one or more additional oils.
Statement 38. The method according to Statement 26 or Statement 27, wherein the spray solution comprises: from about 0.13 wt. % to about 8.90 wt. % one or more oils; from about 4.25 wt. % to about 21.25 wt. % one or more additional oils; and from about 61.0 wt. % to about 94.9 wt. % water.
Statement 39. The method according to any of Statements 16-38, wherein applying the spray solution to the undesired vegetation or its environment comprises contacting the foliage of the undesired vegetation with an herbicidally effective amount of the oil dispersion formulation.
Statement 40. The method according to any one of Statements 1-39, wherein the OD formulation comprises from about 5 wt. % to about 30 wt. % aminocyclopyrachlor in a free-acid form.
Statement 41. The method according to any one of Statements 1-39, wherein the OD formulation comprises from about 5 wt. % to about 20 wt. % aminocyclopyrachlor in a free-acid form.
Statement 42. The method according to any one of Statements 1-39, wherein the OD formulation comprises from about 7 wt. % to about 15 wt. % aminocyclopyrachlor in a free-acid form.
Statement 43. The method according to any one of Statements 1-42, wherein the spray solution comprises from about 0.04 wt. % to about 4.0 wt. % aminocyclopyrachlor in a free-acid form.
Statement 44. The method according to any one of Statements 1-43, wherein the aminocyclopyrachlor in a free-acid form comprises crystals milled to an average particle size less than about 15 micrometers (μm) (D₅₀).
Statement 45. The method according to any one of Statements 1-44, wherein the OD formulation further comprises at least one emulsifier and the aminocyclopyrachlor in a free-acid form are homogeneously suspended or dispersed in the one or more oils.
Statement 46. The method according to any one of Statements 1-45, wherein the OD formulation further comprises at least one emulsifier.
Statement 47. The method according to Statement 46, wherein the OD formulation comprises from about 4 wt. % to about 20 wt. % of the at least one emulsifier.
Statement 48. The method according to Statement 46, wherein the OD formulation comprises from about 5 wt. % to about 15 wt. % of the at least one emulsifier.
Statement 49. The method according to any one of Statements 46-48, wherein the at least one emulsifier is selected from the group consisting of benzenesulfonic acid, 4-C10-13-sec[1]-alkyl derivatives, 2-propanamine, polyethylene glycol (PEG)-40 sorbitan peroleate, sorbitan trioleate ethoxylate, sorbitan monooleate, dodecylbenzolsulfonate isopropylammonium salt, and any combination thereof.
Statement 50. The method according to any one of Statements 1-48, wherein the OD formulation further comprises at least one surfactant.
Statement 51. The method according to Statement 50, wherein the OD formulation comprises from about 2.5 wt. % to about 25 wt. % of the at least one surfactant.
Statement 52. The method according to Statement 50, wherein the OD formulation comprises from about 5 wt. % to about 20 wt. % of the at least one surfactant.
Statement 53. The method according to any one of Statements 50-52, wherein the at least one surfactant is a non-aqueous surfactant.
Statement 54. The method according to any one of Statements 50-52, wherein the at least one surfactant is selected from anionic surfactants, nonionic surfactants, and combinations or mixtures of anionic and nonionic surfactants.
Statement 55. The method according to any one of Statements 50-52, wherein the at least one surfactant is selected from the group consisting of sodium salts of naphthalene sulfonate condensate (NSC) (e.g., anionic naphthalene sulphonate condensates), a tridecyl ether phosphate, an alkylarylsulphonate, an ethylhexanol, an alcohol ethoxylate, and any combination thereof.
Statement 56. The method according to any one of Statements 1-55, wherein the OD formulation further comprises at least one penetration promoter.
Statement 57. The method according to Statement 56, wherein the OD formulation comprises from about 5 wt. % to about 55 wt. % of the at least one penetration promoter.
Statement 58. The method according to Statement 56, wherein the OD formulation comprises from about 15 wt. % to about 40 wt. % of the at least one penetration promoter.
Statement 59. The method according to any one of Statements 56-58, wherein the at least one penetration promoter is selected from the group consisting of isotridecanol ethoxylates, e-ethyl-hexyl alkoxylate, branched alcohol ethoxylate-propoxylates, and any combination thereof.
Statement 60. The method according to any one of Statements 1-59, wherein the OD formulation further comprises one or more additives selected from the group consisting of antifoam agents, inert materials, antioxidants, preservatives, and any combination thereof.
Statement 61. The method according to Statement 60, wherein the OD formulation comprises silicon oil as an antifoaming agent.
Statement 62. The method according to Statement 60 or Statement 61, wherein the OD formulation comprises butylated hydroxytoluene as an antioxidant.
Statement 63. The method according to any of Statements 60-62, wherein the OD formulation comprises from about 0 wt. % to about 15 wt. % of the one or more additives.
Statement 64. The method according to any of Statements 60-62, wherein the OD formulation comprises from about 1 wt. % to about 10 wt. % of the one or more additives.
Statement 65. The method according to any one of Statements 1-64, wherein the spray solution further comprises at least one spray adjuvant.
Statement 66. The method according to Statement 65, wherein the spray solution comprises from about 0.25 vol. % to about 2 vol. % of a methylated seed oil (MSO) as the at least one spray adjuvant.
Statement 67. The method according to any one of Statements 1-66, wherein the OD formulation and/or the spray solution comprises at least one additional agrochemical active compound.
Statement 68. The method according to Statement 67, wherein the OD formulation comprises from about 5 wt. % to about 20 wt. % of the at least one additional agrochemical active compound.
Statement 69. The method according to Statement 67, wherein the OD formulation comprises from about 7 wt. % to about 15 wt. % of the at least one additional agrochemical active compound.
Statement 70. The method according to any one of Statements 67-69, wherein the at least one additional agrochemical active compound is selected from the group consisting of metsulfuron-methyl, picloram, aminopyralid, 2,4-D, dicamba, chlorsulfuron, fluroxypyr, imazapyr, triclopyr, florpyrauxifen, and any combination thereof.
Statement 71. The method according to any of Statements 1-70, wherein the difficult to control weed species demonstrates a greater than 30% foliar brown out 30 days after application.
Statement 72. The method according to any of Statements 1-70, wherein the difficult to control weed species demonstrates a greater than 50% foliar brown out 60 days after treatment or 90 days after application.
Statement 73. The method according to any of Statements 1-70, wherein the difficult to control weed species demonstrates a greater than 60% foliar brown out 60 days after treatment or 90 days after application.
Statement 74. The method according to any of Statements 1-70, wherein the difficult to control weed species demonstrates at least 70% foliar brown out 60 days after treatment or 90 days after application.
Statement 75. The method according to any one of Statements 1-74, further comprising performing a foliar spray treatment using the OD formulation or the spray solution.
Statement 76. The method according to Statement 75, wherein performing the foliar spray treatment comprises applying the spray solution or OD formulation to foliar surfaces of the difficult to control weed species at an application rate ranging from about 100 grams of the agrochemical active compound per hectare (g ai/ha) to about 140 g ai/ha.
Statement 77. The method according to Statement 75, wherein performing the foliar spray treatment comprises performing individual plant treatment (IPT) of the difficult to control weed species.
Statement 78. The method according to Statement 75 or Statement 76, wherein performing the foliar spray treatment comprises performing a broadcast treatment of the difficult to control weed species.
Statement 79. The method according to Statement 75 or Statement 76, wherein performing the foliar spray treatment comprises performing an aerial spray treatment of the difficult to control weed species using a plane, an aerial drone, a helicopter, or any combination thereof.
Statement 80. An oil dispersion (OD) formulation for the treatment of undesired vegetation belonging to one or more difficult to control weed species, the OD formulation comprising: aminocyclopyrachlor in a free-acid form suspended or dispersed in one or more oils.
Statement 81. The OD formulation according to Statement 80, wherein the aminocyclopyrachlor in a free-acid form comprises 6-amino-5-chloro-2-cyclopropylpyrimidine-4-carboxylic acid.
Statement 82. The OD formulation according to Statement 80 or Statement 81, wherein the undesired vegetation is selected from the group consisting of Juniperus osteosperma, Juniperus scopulorum, Juniperus occidentalis, Juniperus virginiana, Juniperus ashei, Juniperus pinchotii, and any combination thereof.
Statement 83. The OD formulation according to Statement 80 or Statement 81, wherein the one or more difficult to control weed species comprises one or more species selected from the group consisting of Juniper spp, Cedrus spp, Kochia, Lespedeza, Sweetgum, Loblolly Pine, Greenbrier, Yaupon Holly, Common Buckthorn, White Birch, Chinese Silverthorn, Leafy Spurge, Pigweed, Cinquefoil, Yellow Toadflax, Texas Bullnettle, Japanese Knotweed, Prickly Pear, Mesquite, Huisache, and Virginia Pine, and any combination thereof.
Statement 84. The OD formulation according to any of Statements 80-83, wherein the OD formulation is effective to control, mitigate, or reduce the undesired vegetation when the OD formulation is applied to the foliage of the undesired vegetation or otherwise used as a foliar spray.
Statement 85. The OD formulation according to Statement 84, wherein the OD formulation is effective to control, mitigate, or reduce the undesired vegetation in the absence of contacting the stem or trunk of the undesired vegetation with the OD formulation.
Statement 86. The OD formulation according to any one of Statements 80-85, wherein the OD formulation comprises from about 15 wt. % to about 70 wt. % of the one or more oils.
Statement 87. The OD formulation according to any one of Statements 80-86, wherein the one or more oils comprises greater than about 55 wt. % of the OD formulation.
Statement 88. The OD formulation according to any one of Statements 80-85, wherein the one or more oils comprises from about 56 wt. % to about 70 wt. % of the OD formulation.
Statement 89. The OD formulation according to any one of Statements 80-88, wherein the one or more oils is selected from the group consisting of mineral oil, sunflower oil, rapeseed oil, soybean oil, and any combination thereof.
Statement 90. The OD formulation according to any one of Statements 80-88, wherein the one or more oils is selected from mineral oil or one or more other petroleum-based aliphatic hydrocarbon oils.
Statement 91. The OD formulation according to any one of Statements 80-88, wherein the one or more oils is selected from vegetable oil, sunflower oil, soybean oil, or one or more other vegetable-based aliphatic hydrocarbon oils.
Statement 92. The OD formulation according to any one of Statements 80-91, wherein the OD formulation is effective when applied directly to the undesired vegetation without dilution.
Statement 93. The OD formulation according to any one of Statements 80-92, wherein the OD formulation substantially excludes water.
Statement 94. The OD formulation according to any one of Statements 80-93, wherein the OD formulation is effective to control, mitigate, or reduce the undesired vegetation when the OD formulation is combined with water or a water-based solution to form a spray solution and the spray solution is applied to the undesired vegetation or its environment.
Statement 95. The OD formulation according to any one of Statements 80-94, wherein the OD formulation comprises from about 5 wt. % to about 30 wt. % aminocyclopyrachlor in a free-acid form.
Statement 96. The OD formulation according to any one of Statements 80-94, wherein the OD formulation comprises from about 5 wt. % to about 20 wt. % aminocyclopyrachlor in a free-acid form.
Statement 97. The OD formulation according to any one of Statements 80-94, wherein the OD formulation comprises from about 7 wt. % to about 15 wt. % aminocyclopyrachlor in a free-acid form.
Statement 98. The OD formulation according to any one of Statements 80-97, wherein the aminocyclopyrachlor in a free-acid form comprises crystals milled to an average particle size less than about 15 micrometers (μm) (D₅₀).
Statement 99. The OD formulation according to any one of Statements 80-98, wherein the OD formulation further comprises at least one emulsifier and the aminocyclopyrachlor in a free-acid form are homogeneously suspended or dispersed in the one or more oils.
Statement 100. The OD formulation according to any one of Statements 80-99, wherein the OD formulation further comprises at least one emulsifier.
Statement 101. The OD formulation according to Statement 100, wherein the OD formulation comprises from about 4 wt. % to about 20 wt. % of the at least one emulsifier.
Statement 102. The OD formulation according to Statement 100, wherein the OD formulation comprises from about 5 wt. % to about 15 wt. % of the at least one emulsifier.
Statement 103. The OD formulation according to any one of Statements 100-102, wherein the at least one emulsifier is selected from the group consisting of benzenesulfonic acid, 4-C10-13-sec[1]-alkyl derivatives, 2-propanamine, polyethylene glycol (PEG)-40 sorbitan peroleate, sorbitan trioleate ethoxylate, sorbitan monooleate, dodecylbenzolsulfonate isopropylammonium salt, and any combination thereof.
Statement 104. The OD formulation according to any one of Statements 80-103, wherein the OD formulation further comprises at least one surfactant.
Statement 105. The OD formulation according to Statement 104, wherein the OD formulation comprises from about 2.5 wt. % to about 25 wt. % of the at least one surfactant.
Statement 106. The OD formulation according to Statement 104, wherein the OD formulation comprises from about 5 wt. % to about 20 wt. % of the at least one surfactant.
Statement 107. The OD formulation according to any one of Statements 104-106, wherein the at least one surfactant is a non-aqueous surfactant.
Statement 108. The OD formulation according to any one of Statements 104-106, wherein the at least one surfactant is selected from anionic surfactants, nonionic surfactants, and combinations or mixtures of anionic and nonionic surfactants.
Statement 109. The OD formulation according to any one of Statements 104-106, wherein the at least one surfactant is selected from the group consisting of sodium salts of naphthalene sulfonate condensate (NSC) (e.g., anionic naphthalene sulphonate condensates), a tridecyl ether phosphate, an alkylarylsulphonate, an ethylhexanol, an alcohol ethoxylate, and any combination thereof.
Statement 110. The OD formulation according to any one of Statements 80-109, wherein the OD formulation further comprises at least one penetration promoter.
Statement 111. The OD formulation according to Statement 110, wherein the OD formulation comprises from about 5 wt. % to about 55 wt. % of the at least one penetration promoter.
Statement 112. The OD formulation according to Statement 110, wherein the OD formulation comprises from about 15 wt. % to about 40 wt. % of the at least one penetration promoter.
Statement 113. The OD formulation according to any one of Statements 110-112, wherein the at least one penetration promoter is selected from the group consisting of isotridecanol ethoxylates, e-ethyl-hexyl alkoxylate, branched alcohol ethoxylate-propoxylates, and any combination thereof.
Statement 114. The OD formulation according to any one of Statements 80-113, wherein the OD formulation further comprises one or more additives selected from the group consisting of antifoam agents, inert materials, antioxidants, preservatives, and any combination thereof.
Statement 115. The OD formulation according to Statement 114, wherein the OD formulation comprises silicon oil as an antifoaming agent.
Statement 116. The OD formulation according to Statement 114 or Statement 115, wherein the OD formulation comprises butylated hydroxytoluene as an antioxidant.
Statement 117. The OD formulation according to any of Statements 114-116, wherein the OD formulation comprises from about 0 wt. % to about 15 wt. % of the one or more additives.
Statement 118. The OD formulation according to any of Statements 114-116, wherein the OD formulation comprises from about 1 wt. % to about 10 wt. % of the one or more additives.
Statement 119. The OD formulation according to any one of Statements 80-118, wherein the OD formulation comprises at least one additional agrochemical active compound.
Statement 120. The OD formulation according to Statement 119, wherein the OD formulation comprises from about 5 wt. % to about 20 wt. % of the at least one additional agrochemical active compound.
Statement 121. The OD formulation according to Statement 119, wherein the OD formulation comprises from about 7 wt. % to about 15 wt. % of the at least one additional agrochemical active compound.
Statement 122. The OD formulation according to any one of Statements 119-121, wherein the at least one additional agrochemical active compound is selected from the group consisting of metsulfuron-methyl, picloram, aminopyralid, 2,4-D, dicamba, chlorsulfuron, fluroxypyr, imazapyr, triclopyr, florpyrauxifen, and any combination thereof.
Statement 123. The OD formulation according to any of Statements 80-122, wherein the difficult to control weed species demonstrates a greater than 30% foliar brown out 30 days after application.
Statement 124. The OD formulation according to any of Statements 80-122, wherein the difficult to control weed species demonstrates a greater than 50% foliar brown out 60 days after treatment or 90 days after application.
Statement 125. The OD formulation according to any of Statements 80-122, wherein the difficult to control weed species demonstrates a greater than 60% foliar brown out 60 days after treatment or 90 days after application.
Statement 126. The OD formulation according to any of Statements 80-122, wherein the difficult to control weed species demonstrates at least 70% foliar brown out 60 days after treatment or 90 days after application.
Statement 127. A spray solution for the treatment of undesired vegetation belonging to one or more difficult to control weed species, the spray solution comprising: the OD formulation according to any one of Statements 80-126; and water.
Statement 128. The spray solution according to Statement 127, wherein the spray solution is formed by combining the OD formulation according to any one of Statements 80-126 with water or a water-based solution to form the spray solution.
Statement 129. The spray solution according to Statement 127 or Statement 128, wherein the spray solution comprises from about 1 volume percent (vol. %) to about 15 vol. % of the OD formulation and at least 80 vol. % water.
Statement 130. The spray solution according to Statement 127 or Statement 128, wherein the spray solution comprises from about 80 vol. % to about 99 vol. % water.
Statement 131. The spray solution according to Statement 127 or Statement 128, wherein the spray solution comprises from about 85 vol. % to about 99 vol. % water.
Statement 132. The spray solution according to any one of Statements 127-131, wherein the spray solution comprises from about 0.25 vol. % to about 2 vol. % methylated seed oil (MSO).
Statement 133. The spray solution according to any one of Statements 127-132, wherein the spray solution comprises from about 0.13 wt. % to about 8.90 wt. % oil.
Statement 134. The spray solution according to any one of Statements 127-133, wherein the spray solution comprises greater than 0.1 wt. % oil.
Statement 135. The spray solution according to any one of Statements 127-133, wherein the spray solution comprises at least 0.13 wt. % oil.
Statement 136. The spray solution according to any one of Statements 127-128 and 132-135, wherein the spray solution comprises from about 82.0 wt. % to about 99.2 wt. % water.
Statement 137. The spray solution according to any one of Statements 127-136, wherein the spray solution comprises from about 0.20 wt. % to about 1.8 wt. % methylated seed oil (MSO).
Statement 138. The spray solution according to any one of Statements 127-137, further comprising one or more additional oils.
Statement 139. The spray solution according to Statement 138, wherein the spray solution is formed by combining the OD formulation according to any one of Statements 80-126 with water or a water-based solution, and one or more additional oils to form the spray solution.
Statement 140. The spray solution according to Statement 138 or Statement 139, wherein the one or more additional oils comprises one or more aliphatic hydrocarbon oils.
Statement 141. The spray solution according to any one of Statements 138-140, wherein the spray solution comprises less than 95 vol. % water.
Statement 142. The spray solution according to any one of Statements 138-141, wherein the spray solution comprises: from about 1 volume percent (vol. %) to about 15 vol. % OD formulation; from about 5 vol. % to about 25 vol. % one or more additional oils; and from about 60 vol. % to about 94 vol. % water.
Statement 143. The spray solution according to any one of Statements 138-142, wherein the spray solution comprises at least 74 vol. % water.
Statement 144. The spray solution according to any one of Statements 138-142, wherein the spray solution comprises at least 75 vol. % water.
Statement 145. The spray solution according to any one of Statements 138-142, wherein the spray solution comprises at least 80 vol. % water.
Statement 146. The spray solution according to any one of Statements 138-145, wherein the spray solution comprises from about 0.25 vol. % to about 2 vol. % methylated seed oil (MSO).
Statement 147. The spray solution according to any one of Statements 138-146, wherein the spray solution comprises less than 95% by weight water.
Statement 148. The spray solution according to any one of Statements 138-146, wherein the spray solution comprises from about 60% to about 94.9% by weight water.
Statement 149. The spray solution according to any one of Statements 138-148, wherein the total amount by weight of oil in the spray solution is at least 4.3 wt. %, the total amount of oil being the oil in the spray solution contributed by the one or more oils in the OD formulation and the one or more additional oils.
Statement 150. The spray solution according to any one of Statements 138-148, wherein the total oil weight percentage of the spray solution comprises from about 4.3% to about 30.2% by weight oil, the total oil weight percentage being the combined weight percentage of the oil in the spray solution contributed by the one or more oils in the OD formulation and the one or more additional oils.
Statement 151. The spray solution according to any one of Statements 138-150, wherein the spray solution comprises: from about 0.13 wt. % to about 8.90 wt. % one or more oils; from about 4.25 wt. % to about 21.25 wt. % one or more additional oils; and from about 61.0 wt. % to about 94.9 wt. % water.
Statement 152. The spray solution according to any one of Statements 127-151, wherein the spray solution comprises from about 0.04 wt. % to about 4.0 wt. % aminocyclopyrachlor in a free-acid form.
Statement 153. The spray solution according to any one of Statements 127-152, wherein the aminocyclopyrachlor in a free-acid form comprises crystals milled to an average particle size less than about 15 micrometers (μm) (D₅₀).
Statement 154. The spray solution according to any one of Statements 127-153, wherein the spray solution further comprises at least one spray adjuvant.
Statement 155. The spray solution according to Statement 154, wherein the spray solution comprises from about 0.25 vol. % to about 2 vol. % of a methylated seed oil (MSO) as the at least one spray adjuvant.
Statement 156. The spray solution according to any one of Statements 127-155, wherein the spray solution comprises at least one additional agrochemical active compound.
Statement 157. The spray solution according to Statement 156, wherein the at least one additional agrochemical active compound is selected from the group consisting of metsulfuron-methyl, picloram, aminopyralid, 2,4-D, dicamba, chlorsulfuron, fluroxypyr, imazapyr, triclopyr, florpyrauxifen, and any combination thereof.
Statement 158. The spray solution according to any of Statements 127-157, wherein the difficult to control weed species demonstrates a greater than 30% foliar brown out 30 days after application.
Statement 159. The spray solution according to any of Statements 127-157, wherein the difficult to control weed species demonstrates a greater than 50% foliar brown out 60 days after treatment or 90 days after application.
Statement 160. The spray solution according to any of Statements 127-157, wherein the difficult to control weed species demonstrates a greater than 60% foliar brown out 60 days after treatment or 90 days after application.
Statement 161. The spray solution according to any of Statements 127-157, wherein the difficult to control weed species demonstrates at least 70% foliar brown out 60 days after treatment or 90 days after application.
Statement 162. A method of using an oil dispersion (OD) formulation for the treatment of undesired vegetation belonging to one or more difficult to control weed species, the method comprising: providing an OD formulation according to any one of Statements 80-126; combining the OD formulation with water or a water-based solution to form a spray solution; and performing a foliar spray treatment of the undesired vegetation using the spray solution.
Statement 163. The method according to Statement 162, wherein the spray solution formed is a spray solution according to any one of Statements 127-161.
Statement 164. The method according to Statement 162 or Statement 163, wherein the undesired vegetation is selected from the group consisting of Juniperus osteosperma, Juniperus scopulorum, Juniperus occidentalis, Juniperus virginiana, Juniperus ashei, Juniperus pinchotii, and any combination thereof.
Statement 165. The method according to Statement 162 or Statement 163, wherein the one or more difficult to control weed species comprises one or more species selected from the group consisting of Juniper spp, Cedrus spp, Kochia, Lespedeza, Sweetgum, Loblolly Pine, Greenbrier, Yaupon Holly, Common Buckthorn, White Birch, Chinese Silverthorn, Leafy Spurge, Pigweed, Cinquefoil, Yellow Toadflax, Texas Bullnettle, Japanese Knotweed, Prickly Pear, Mesquite, Huisache, and Virginia Pine, and any combination thereof.
Statement 166. A method of manufacturing an oil dispersion (OD) formulation for the treatment of one or more difficult to control weed species, the method comprising: milling aminocyclopyrachlor in a free-acid form to yield a milled solid composition of aminocyclopyrachlor in a free-acid form, the milled solid composition having an average particle size less than about 15 micrometers (μm) (D₅₀); combining the milled solid composition with one or more oils to yield the OD formulation, the OD formulation comprising a substantially homogeneous dispersion or suspension of aminocyclopyrachlor in a free-acid form suspended or dispersed in the one or more oils.
Statement 167. The method according to Statement 166, wherein the milling comprises dry milling crystals of aminocyclopyrachlor in a free-acid form to an average particle size ranging from about 4 μm and about 10 μm (D₅₀).
Statement 168. The method according to Statement 166 or Statement 167, wherein the aminocyclopyrachlor in a free-acid form comprises 6-amino-5-chloro-2-cyclopropylpyrimidine-4-carboxylic acid.

1. A method for controlling, mitigating, or reducing undesired vegetation belonging to one or more difficult to control weed species, the method comprising:
applying to the undesired vegetation or its environment an herbicidally effective amount of an oil dispersion formulation, the oil dispersion formulation comprising aminocyclopyrachlor in a free-acid form suspended or dispersed in one or more oils, the oil dispersion formulation comprising from about 15 wt. % to about 70 wt. % of the one or more oils, and wherein the oil dispersion formulation is substantially free of water.

2. The method according to claim 1, wherein the aminocyclopyrachlor in a free-acid form comprises 6-amino-5-chloro-2-cyclopropylpyrimidine-4-carboxylic acid.

3. The method according to claim 1, wherein the undesired vegetation is selected from the group consisting of Juniperus osteosperma, Juniperus scopulorum, Juniperus occidentalis, Juniperus virginiana, Juniperus ashei, Juniperus pinchotii, and any combination thereof.

4. The method according to claim 1, wherein the one or more difficult to control weed species comprises one or more species selected from the group consisting of Juniper spp, Cedrus spp, Kochia, Lespedeza, Sweetgum, Loblolly Pine, Greenbrier, Yaupon Holly, Common Buckthorn, White Birch, Chinese Silverthorn, Leafy Spurge, Pigweed, Cinquefoil, Yellow Toadflax, Texas Bullnettle, Japanese Knotweed, Prickly Pear, Mesquite, Huisache, and Virginia Pine, and any combination thereof.

5. The method according to claim 1, wherein applying to the undesired vegetation or its environment comprises contacting the foliage of the undesired vegetation with an herbicidally effective amount of the oil dispersion formulation or applying the oil dispersion formulation as a foliar spray to the foliage of the undesired vegetation.

6. The method according to claim 1, wherein the oil dispersion formulation comprises from about 15 wt. % to about 70 wt. % of the one or more oils, wherein the one or more oils is selected from the group consisting of mineral oil, sunflower oil, rapeseed oil, soybean oil, and any combination thereof.

7. The method according to claim 1, wherein the oil dispersion formulation comprises:
from about 5 wt. % to about 30 wt. % aminocyclopyrachlor in a free-acid form;
from about 4 wt. % to about 20 wt. % of at least one emulsifier;
from about 2.5 wt. % to about 25 wt. % of at least one surfactant;
from about 5 wt. % to about 55 wt. % of at least one penetration promoter.

8. The method according to claim 1, wherein applying to the undesired vegetation or its environment an herbicidally effective amount of an oil dispersion formulation comprises:
combining the oil dispersion formulation with water or a water-based solution to form a spray solution, wherein the spray solution comprises from about 1 volume percent (vol. %) to about 15 vol. % of the OD formulation and at least 80 vol. % water; and
applying the spray solution to the undesired vegetation or its environment.

9. The method according to claim 8, wherein the spray solution comprises from about 0.13 wt. % to about 8.90 wt. % oil and from about 82.0 wt. % to about 99.2 wt. % water.

10. The method according to claim 1, wherein applying to the undesired vegetation or its environment an herbicidally effective amount of an oil dispersion formulation comprises:
combining the oil dispersion formulation with water and one or more additional oils to form a spray solution; and
applying the spray solution to the undesired vegetation or its environment.

11. The method according to claim 10, wherein the one or more additional oils comprises one or more aliphatic hydrocarbon oils.

12. The method according to claim 11, wherein the spray solution comprises:
from about 1 volume percent (vol. %) to about 15 vol. % OD formulation;
from about 5 vol. % to about 25 vol. % one or more additional oils; and
from about 60 vol. % to about 94 vol. % water.

13. The method according to claim 11, wherein the spray solution comprises from about 60% to about 94.9% by weight water, wherein the total oil weight percentage of the spray solution comprises from about 4.3% to about 30.2% by weight oil, the total oil weight percentage being the combined weight percentage of the oil in the spray solution contributed by the one or more oils in the oil dispersion formulation and the one or more additional oils.

14. The method according to claim 11, wherein the spray solution comprises:
from about 0.13 wt. % to about 8.90 wt. % one or more oils;
from about 4.25 wt. % to about 21.25 wt. % one or more additional oils;
from about 61.0 wt. % to about 94.9 wt. % water; and
from about 0.04 wt. % to about 4.0 wt. % aminocyclopyrachlor in a free-acid form.

15. The method according to claim 1, further comprising applying the oil dispersion formulation to foliar surfaces of the difficult to control weed species at an application rate ranging from about 100 grams of aminocyclopyrachlor in a free-acid form active ingredient (ai) per hectare (g ai/ha) to about 140 g ai/ha.

16. An oil dispersion (OD) formulation for the treatment of undesired vegetation belonging to one or more difficult to control weed species, the OD formulation comprising:
from about 5 wt. % to about 30 wt. % aminocyclopyrachlor in a free-acid form;
from about 4 wt. % to about 20 wt. % of at least one emulsifier;
from about 2.5 wt. % to about 25 wt. % of at least one surfactant;
from about 5 wt. % to about 55 wt. % of at least one penetration promoter.

17. A spray solution for the treatment of undesired vegetation belonging to one or more difficult to control weed species, the spray solution comprising an OD formulation and water, OD formulation comprising:
from about 5 wt. % to about 30 wt. % aminocyclopyrachlor in a free-acid form;
from about 4 wt. % to about 20 wt. % of at least one emulsifier;
from about 2.5 wt. % to about 25 wt. % of at least one surfactant;
from about 5 wt. % to about 55 wt. % of at least one penetration promoter.

18. The spray solution according to claim 17, wherein the spray solution is formed by combining the OD formulation with water or a water-based solution and the spray solution comprises from about 1 volume percent (vol. %) to about 15 vol. % of the OD formulation and at least 80 vol. % water.

19. The spray solution according to claim 17, further comprising one or more additional oils selected from one or more aliphatic hydrocarbon oils, the spray solution comprising:
from about 1 volume percent (vol. %) to about 15 vol. % OD formulation;
from about 5 vol. % to about 25 vol. % one or more additional oils; and
from about 60 vol. % to about 94 vol. % water.

20. The spray solution according to claim 17, wherein the spray solution comprises:
from about 0.13 wt. % to about 8.90 wt. % one or more oils;
from about 4.25 wt. % to about 21.25 wt. % one or more additional oils selected from one or more aliphatic hydrocarbon oils;
from about 61.0 wt. % to about 94.9 wt. % water; and
from about 0.04 wt. % to about 4.0 wt. % aminocyclopyrachlor in a free-acid form.

21. A method for controlling, mitigating, or reducing undesired vegetation belonging to one or more difficult to control weed species, the method comprising:
applying to the undesired vegetation or its environment an herbicidally effective amount of an oil dispersion formulation, the oil dispersion formulation comprising an active ingredient component suspended or dispersed in one or more oils, wherein the active ingredient component consists essentially of aminocyclopyrachlor in a free-acid form.
